(19) United States
(12) Patent Application Publication
(10) Pub. No.: US 2024/0373292 A1
(43) Pub. Date: Nov. 7, 2024

(54) SYSTEM AND METHOD FOR IMPROVING WIRELESS COMMUNICATIONS

(71) Applicant: VERIZON PATENT AND LICENSING INC., Basking Ridge, NJ (US)

(72) Inventors: Jin YANG, Orinda, CA (US); Sudhir PATEL, Boonton, NJ (US)

(73) Assignee: VERIZON PATENT AND LICENSING INC., Basking Ridge, NJ (US)

(21) Appl. No.: 18/312,706

(22) Filed: May 5, 2023

(51) Int. Cl. H04W 28/18; H04W 24/10; H04W 76/10

(52) U.S. Cl. CPC H04W 28/18; H04W 24/10; H04W 76/10

(57) ABSTRACT

In the present disclosure, systems and methods are disclosed for improving the quality and performance of communications between a User Equipment (UE) and a base station of an access network by inducing the base station to modify a configuration parameter corresponding to the connection with the UE. In some embodiments, during and/or after a connection has been established between the UE and the base station, the UE can determine an adjusted Channel Quality Indicator (CQI) value based on a signal parameter and an adjustment value, and report the adjusted CQI value to the base station.

### BACKGROUND

As 5G New Radio (NR) becomes the predominant technology in wireless communications networks, User Equipment (UE) with multi-antenna receivers will outpace UE with single-antenna receiver (RX) designs. However, for applications where cost, size, and power consumption are considerations, single-antenna RX UE may be a viable design choice. Current standards involved in 5G NR may negatively adjust the receiver sensitivity for some single-antenna RX UE when compared to dual or multi-antenna RX UE leading to a decrease in coverage and a decrease in performance by the single-antenna RX UE.

### BRIEF DESCRIPTION OF THE DRAWINGS

The foregoing and other objects, features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a block diagram illustrating an example environment within which the systems and methods disclosed herein could be implemented according to an embodiment.

FIG. 2 is a flow diagram illustrating a method for generating an adjusted Channel Quality Indicator (CQI) value according to an embodiment.

FIG. 3 is a flow diagram illustrating a method for determining an adjustment value according to an embodiment.

FIG. 4 is a block diagram of a device according to some embodiments.

### DETAILED DESCRIPTION

In the present disclosure, systems and methods are disclosed for improving the quality and performance of communications between a UE and a base station of an access network by inducing the base station to modify a configuration parameter corresponding to the connection with the UE. In some embodiments, during and/or after a connection has been established between the UE and the base station, the UE can determine an adjusted CQI value, and report the adjusted CQI value to the base station.

In some embodiments, a CQI value can be an index value in a predetermined range, with higher values indicating better channel quality. In some embodiments, a UE can determine the CQI value based on one or more radio frequency (RF) signal parameters. In some embodiments, RF signal parameters can include signal strength, signal-to-noise ratio (SNR), signal-to-interference-plus-noise ratio (SINR), signal-to-interference-plus-distortion ratio (SNDR).

In some embodiments, to determine or generate an adjusted CQI value, the UE can vary at least one of the signal parameters by an adjustment value. For example, in some embodiments, the adjustment value can be between 0 dB and about 3 dB. In some embodiments, the adjustment value can be greater than 3 dB. In some embodiments, varying the signal parameter can include reducing the signal parameter by an adjustment value. In some embodiments, varying the signal parameter can include increasing the signal parameter by an adjustment value.

In some embodiments, upon receiving the adjusted CQI value, the base station can modify network configuration parameters based on the received adjusted CQI value to optimize the connection performance and reliability. In some embodiments, modifying a configuration parameter can include selecting a Modulation and Coding Scheme (MCS). In those embodiments, the base station can adapt the MCS based on the adjusted CQI value. In some embodiments, where a higher CQI value indicates better channel quality, the base station can use higher-order modulation schemes (e.g., 64-QAM, 256-QAM, etc.) and lower coding rates, resulting in higher data rates. In some embodiments, where a lower CQI value indicates lower channel quality, the base station can use lower-order modulation schemes (e.g., QPSK, 16-QAM, etc.) and higher coding rates.

In some embodiments, modifying a configuration parameter can include allocating radio resources such as time slots and frequency blocks. In some embodiments, UEs with better channel conditions can be assigned more resources to increase performance. In some embodiments, modifying a configuration parameter can include directing the base station scheduler to prioritize UEs based on the adjusted CQI value. In some embodiments, modifying a configuration parameter can include adjusting transmission power.

In some embodiments, the adjustment value can be a predetermined value hardwired into the UE. In some embodiments, the adjustment value can be a variable value. In some of those embodiments, the UE can determine which adjustment value to apply based on an actual CQI value (e.g., not adjusted). For example, in some embodiments, the UE can maintain a table of actual CQI values and corresponding adjustment values to apply to the signal parameters to obtain an adjusted CQI value.

In some embodiments, the adjustment value can be received at the UE from a third-party (e.g., network operators (NOs), device manufacturers, service providers, etc.). In some embodiments, the adjustment value can be received periodically or as determined by the third party. In some embodiments, the third-party may remotely reconfigure the UE to set or otherwise change an adjustment value by transmitting instructions from another device or Network Function (NF) to the UE.

In some embodiments, to enable remote configuration of the UE by a third-party, the UE can include software and/or hardware elements to implement a novel device management (DM) node. In some embodiments, the DM node can enable the third party to remotely manage and configure the UE using a DM protocol. In some embodiments, the third party may transmit configuration instructions including the adjustment value using the DM protocol. In some embodiments, the DM protocol can be the Open Mobile Alliance (OMA) Device Management (OMA DM) protocol. In some embodiments, the DM protocol can be the OMA Lightweight Machine to Machine (LwM2M) protocol. In some embodiments, the DM protocol can be any protocol, known or to be known, capable of enabling remote management, configuration, and monitoring of a UE. In some embodiments, the DM protocol can enable remote configuration of a UE's settings, such as data bearer settings, email accounts, and VPN connections; enable Firmware Over-the-Air (FOTA) updates; and/or enable collection of device diagnostics.

In some embodiments, the configuration instructions can be sent from a network element of the access network or a core network, a data network, or a Mobile Edge/Multi-Access Edge Computing (MEC) network communicatively coupled to the access network. For example, in some embodiments, the network element can be a server of the MEC network. In some embodiments, the network element can be a mobility manager of a core network, as described herein. In some embodiments, the configuration instructions can be sent/received by the UE during the session establishment process between the UE and the base station. In some embodiments, configuration instructions can be sent/received periodically. In some embodiments, the UE can adopt the configuration contained in the configuration instructions immediately after receipt of the configuration instructions or after a power cycle of the UE.

In some embodiments, the network element can determine the appropriate adjustment value based on UE characteristics such as RX antenna design (e.g., single-antenna RX v. multi-antenna RX) and/or on network characteristics such as a subscriber group (e.g., Service Profile Identifier (SPID) or Radio Access Technology (RAT) frequency selection priority (RFSP)), Quality of Service (QOS) flow (e.g., QCI/5QI), and/or slicing identifier (e.g., Single-Network Slice Selection Assistance Information (e.g., S-NSSAI)).

In some embodiments, the network element can obtain the UE characteristics and/or network characteristics from a subscriber database, as described herein. In some embodiments, the network element can obtain the UE characteristics and/or network characteristics during the session establishment process. In some embodiments, the UE characteristics can include or otherwise indicate a UE type, as described in relation to UE 102. In some embodiments, the adjustment value can be based on a bandwidth allocation to the connection between the UE and the base station.

In some aspects, the techniques described herein relate to a method that determines a signal parameter corresponding to a signal between a UE and a base station of an access network and modifies the signal parameter to generated an adjusted CQI value. Then, the UE can provide the adjusted CQI value to the base station and the base station, in turn, can change parameters or characteristics of the communications between the UE and the base station to improve the performance of said communications. In some aspects, the adjusted CQI value can be generated by modifying the signal parameter by an adjustment value received by the UE from a network element communicatively coupled to the base station.

In some aspects, the signal parameter can be a signal strength, an SNR, an SINR, and an SNDR.

In some aspects, the UE can be a single-antenna receiver UE. In some aspects, the adjustment value can be determined by the network element based on a UE characteristic, a network characteristic, or both. In some aspects, the UE characteristic and the network characteristic can be obtained by the network element from a subscriber database of a core network communicatively coupled to the access network.

In some aspects, the UE can comprise a device management (DM) node. In some aspects, the UE can receive configuration instructions including the adjustment value from the network element at the DM node using a DM protocol. In some aspects, the DM protocol can be selected from the group comprising the OMA DM protocol and the LwM2M protocol.

In some aspects, the techniques described herein relate to a non-transitory computer-readable storage medium for storing instructions executable by a processor, where the instructions comprise establishing a communications session between the UE and the base station and receiving, from a network element communicatively coupled to the access network corresponding to the base station, an adjustment value corresponding to the UE. In some embodiments, the instructions further comprise determining a signal parameter corresponding to a signal between the UE and the base station and modifying the signal parameter based on the adjustment value. Then, in some aspects, the instructions comprise generating an adjusted CQI value based on the modified signal parameter and reporting, to the base station, the adjusted CQI value.

In some aspects, the techniques described herein relate to a device comprising a processor configured to establish a communications session with a base station of an access network and receive, from a network element communicatively coupled to the access network, an adjustment value corresponding to the device. In some aspects, the processor is further configured to determine a signal parameter corresponding to a signal between the device and the base station and modify the signal parameter based on the adjustment value. In some aspects the processor is also configured to generate an adjusted CQI value based on the modified signal parameter and report to the base station the adjusted CQI value.

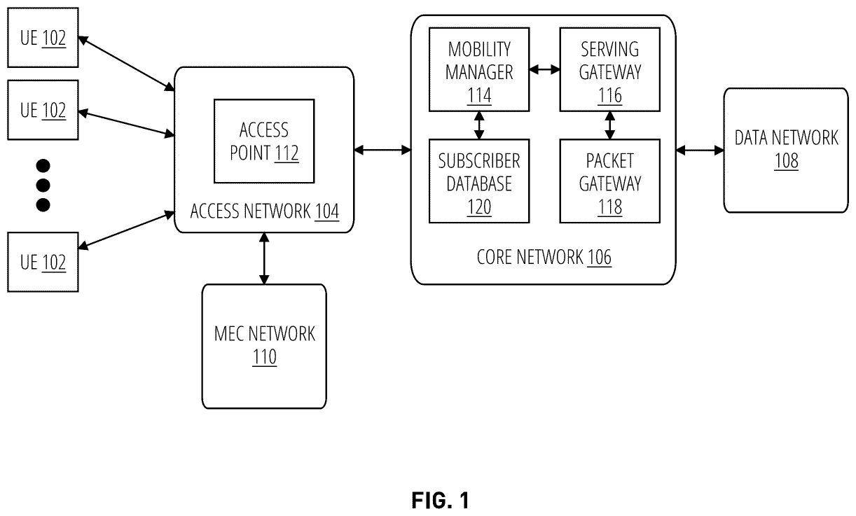

FIG. 1 is a block diagram illustrating an example environment within which the systems and methods disclosed herein could be implemented according to an embodiment.

FIG. 1 shows components of a general environment in which the systems and methods discussed herein may be practiced. Not all the components may be required to practice the disclosure, and variations in the arrangement and type of the components may be made without departing from the spirit or scope of the disclosure. In some embodiments, access network 104, core network 106, and/or data network 108 can include a one or more network elements to allow for the efficient routing of calls, messages, or other forms of conveying information (e.g., multimedia) from a device of a user (e.g., UE) to another device in access network 104, core network 106, and/or data network 108. In some embodiments, network elements may be physical elements such as router, servers and switches or may be virtual NFs implemented on physical elements.

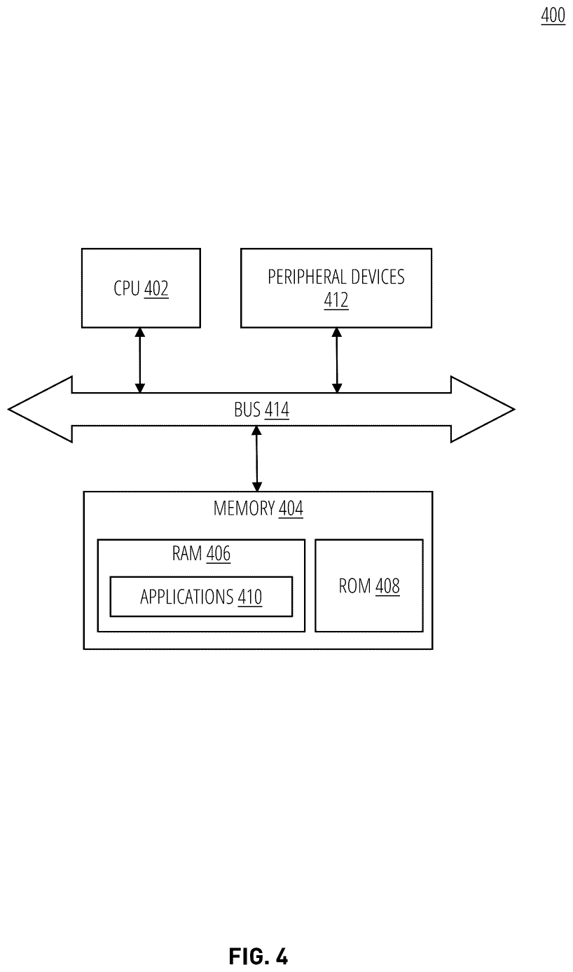

In the illustrated embodiment, one or more UE 102 can be communicatively coupled to a data network 108 and/or MEC Network 110 via an access network 104 and/or a core network 106. In some embodiments, UE 102 can comprise any computing device capable of communicating with the access network 104. In some embodiments, UE 102 can be device 400 as described with respect to FIG. 4. No limit is placed on the type of UE. For example, in some embodiments, UE 102 can be Ultra-Reliable Low Latency Communications (URLLC) devices such as autonomous vehicle computing devices, Internet of Things (IoT) devices, remote surgery devices, etc. In some embodiments, UE 102 can be enhanced mobile broadband (eMBB) devices such as smartphones, tablets, etc. In some embodiments, UE 102 can be Massive Machine-Type Communications (mMTC) devices such as sensors, meters, and monitoring devices.

In some embodiments, UE 102 can be communicatively connected to one or more access points 112 of access network 104. In some embodiments, the access network 104 can comprise a cellular access network, for example, a fifth-generation (5G) network or a fourth-generation (4G) network. In some embodiments, the access network 104 can comprise a NextGen Radio Access Network (NG-RAN). In an embodiment, access point 112 can comprise one or more gNodeB (gNB) base stations connected to UE 102 via an air interface. In an embodiment, the air interface can comprise a New Radio (NR) air interface. For example, in a 5G network, UE 102 can be communicatively coupled to each other, and in some embodiments, for example, such coupling can be via Wi-Fi functionality, Bluetooth, or other forms of spectrum technologies, and the like. In some embodiments, the gNodeB can include multiple network interfaces for communicating with core network 106 and, specifically, mobility manager 114 and serving gateway 116 (S-GW).

In some embodiments, access point 112 can comprise eNodeB (eNB) base stations connected to UE 102 via an air interface. In some embodiments, the air interface can comprise an E-UTRAN Uu or LTE Uu radio air interface. In these embodiments, the eNodeB can provide all functionality to implement and operate the air interface and negotiates uplinks and downlinks with the UE 102. In some embodiments, the eNodeB can also include multiple network interfaces for communicating with the core network 106 and, specifically, mobility manager 114 and serving gateway 116.

In some embodiments, access point 112 can include both a gNodeB base station and an cNodeB base station. In some embodiments, UE 102 can connect to both a gNodeB base station and an cNodeB base station in a dual connectivity (DC) setup.

According to some embodiments, the access network 104 can provide UE 102 access to a core network 106. In the illustrated embodiment, the core network may be owned and/or operated by a network operator (NO) and provides wireless connectivity to UE 102 via access network 104. In the illustrated embodiment, this connectivity may comprise voice and data services. In the illustrated embodiment, the access network 104 and the core network 106 may be operated by a NO. However, in some embodiments, the networks (104, 106) may be operated by a private entity, different entities, and the like, and may be closed to public traffic. In these embodiments, the operator of the device can simulate a cellular network, and UE 102 can connect to this network similar to connecting to a national or regional network.

At a high-level, the core network 106 may include a user plane and a control plane. In one embodiment, the control plane comprises network elements and communications interfaces to allow for the management of user connections and sessions. By contrast, the user plane may comprise network elements and communications interfaces to transmit user data from UE 102 to elements of the core network 106 and to external network-attached elements in a data network 108 such as, but not limited to, the Internet, a local area network (LAN), a wireless LAN, a wide area network (WAN), a multi-access edge computing (MEC) network, a private network, a cellular network, and the like.

In some embodiments, core network 106 can include a mobility manager 114 communicatively coupled to a serving gateway 116 and/or a subscriber database 120. In one embodiment, the mobility manager 114 can comprise an Access and Mobility Management Function (AMF) in a 5G network. In one embodiment, the serving gateway 116 can comprise a Session Management Function (SMF) for control data or User Plane Function (UPF) for user data. In one embodiment, the mobility manager 114 can comprise a Mobile Management Entity (MME) in a 4G network.

In some embodiments, the mobility manager 114 manages control plane traffic while the gateway elements-serving gateway 116 and/or packet gateway 118-manage user data traffic. In some embodiments, the mobility manager 114 can comprise hardware or software for handling network attachment requests from UE 102. As part of processing these requests, in some embodiments, the mobility manager 114 can access the subscriber database 120. In some embodiments, subscriber database 120 can comprise hardware or software that stores user authorization and authentication data and validates users to the network. In some embodiments. the subscriber database 120 can comprise a Unified Data Management (UDM) and Unified Data Repository (UDR) in a 5G network. In some embodiments, the subscriber database 120 can comprise an Home Subscriber Server (HSS) in a 4G network.

In some embodiments, the subscriber database 120 can also store a location of the user updated via a Diameter Protocol or similar protocol. In some embodiments, the Diameter protocol is a networking protocol that is used for authentication, authorization, and accounting (AAA) in mobile networks. In some embodiments, the Diameter protocol can be used to communicate information about a UE's location to other elements of the network, such as the core network 106 or a location server. In some embodiments, this information can include the device's GPS coordinates, as well as other data such as cell tower or Wi-Fi access point (e.g., access points 112) information that can be used to determine its location.

In some embodiments, the mobility manager 114 can also be configured to create data sessions or bearers between UE 102 and serving gateway 116 or packet gateway 118. In one embodiment, the gateways 116 and/or 118 may comprise single or separate devices. In general, the serving gateway 116 can route and forward user data packets while also acting as the mobility anchor for the user plane during access point handovers and as the anchor for mobility between different network technologies. In some embodiments, for UEs entering idle state, the serving gateway 116 can terminate the downlink data path and trigger paging when downlink data arrives for the UE 102. In some embodiments, serving gateway 116 can manage and store UE 102 contexts, e.g., parameters of the IP bearer service, network internal routing information. In some embodiments, in a 5G network, the serving gateway 116 can be implemented by an SMF. In some embodiments, in a 4G network, the serving gateway 116 can be implemented by a Serving Gateway (S-GW).

In some embodiments, serving gateway 116 can be communicatively coupled to the packet gateway 118. In some embodiments, the packet gateway 118 can provide connectivity from the UE 102 to external Packet Data Networks (PDNs) such as data network 108 by being the point of exit and entry of traffic to external networks (e.g., data network 108). In some embodiments, UE 102 can have simultaneous connectivity with a plurality of gateways, including packet gateway 118 for accessing multiple packet data networks. In some embodiments, packet gateway 118 can perform policy enforcement, packet filtering for each user, charging support, lawful interception, and packet screening. In some embodiments, in a 5G network, the packet gateway 118 can be implemented by a UPF. In some embodiments, in a 4G network, the packet gateway 118 can be implemented by a Packet Data Network Gateway (P-GW).

According to some embodiments, UE 102 can be communicatively coupled to data network 108 via access network 104 and core network 106. In one embodiment, the data network 108 may comprise the Internet.

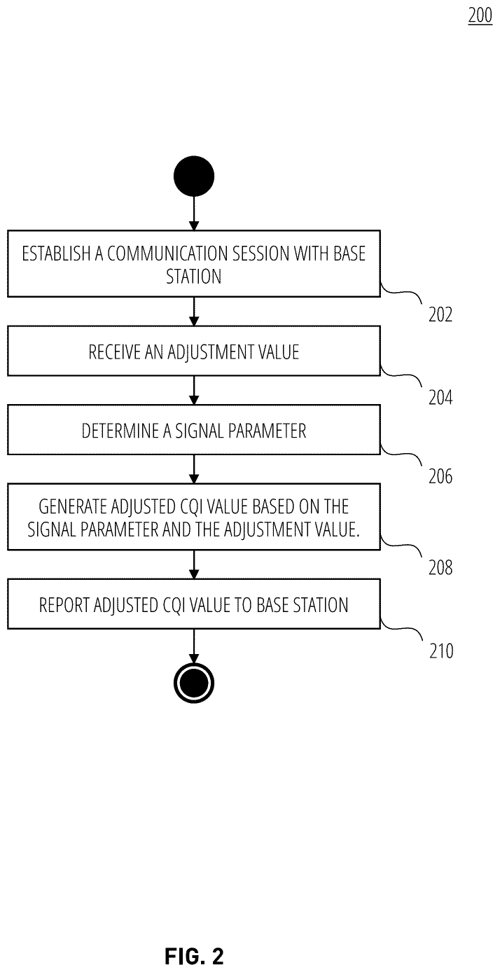

FIG. 2 is a flow diagram illustrating a method for generating an adjusted CQI value according to an embodiment.

In Step 202, method 200 can include establishing, by a UE (e.g., UE 102), a communications session with a base station (e.g., of access point 112) of an access network (e.g., access network 104). In some embodiments, in Step 202, method 200 can include the UE scanning for available base stations by searching for their synchronization signals and, once the UE detects and synchronizes with a cell, it can decode the cell's Broadcast Channel (BCH) to obtain essential system information. Then, in some embodiments, the UE can initiate a connection with the base station by transmitting a random access preamble to the base station and, in response, the base station can send a Random Access Response (RAR) message. In some embodiments, after completing the random access procedure, the UE can send an RRC Connection Request message to the base station and the base station can respond with an RRC Connection Setup message containing the necessary configuration information for the UE to establish the RRC connection.

In some embodiments, after the RRC connection has been established method 200 can proceed to Step 204. Optionally, in some embodiments, Step 202 can include, once the RRC connection is established, authenticating the UE using UE credentials (e.g., International Mobile Subscriber Identity (IMSI)). Then, in some embodiments, the UE can send Non-Access Stratum (NAS) message to the network to request the establishment of a session. In some embodiments, the NAS message can include UE and/or network characteristics such as the UE type, requested services (e.g., data or voice services), and any necessary Quality of Service (QoS) parameters.

In Step 204, method 200 can include receiving at the UE from a network element configuration instructions including an adjustment value. In some embodiments, the adjustment value can be received from an MEC device on an MEC network communicatively coupled to the access network or from an NF of the access network, a core network communicatively coupled to the access network, or a data network communicatively coupled to the access network through the core network.

In Step 206, method 200 can include determining at least one signal parameter corresponding to a signal between the UE and the base station. In some embodiments, the signal parameter can be a signal strength, an SNR, an SINR, and an SNDR. In some embodiments, to determine signal strength, the UE can measure Reference Signal Received Power (RSRP) or the Received Signal Strength Indicator (RSSI). In some embodiments, to determine the SNR, the UE can calculate the ratio of the received signal power to the noise power by dividing the received signal power (e.g., RSRP) by the noise power in the same bandwidth. In some embodiments, to determine the SINR, the UE can measure the received signal power (e.g., RSRP) and the interference power from other cells (e.g., Reference Signal Interference Power (RSIP)) and the noise power, then, the SINR can be computed as the ratio of the signal power to the sum of the interference and noise power. In some embodiments, to determine the SNDR, the UE can determine the received signal power, noise power, and distortion power, then, the SNDR is calculated as the ratio of the signal power to the sum of the noise and distortion power.

In Step 208, method 200 can include generating an adjusted CQI value based on the at least one signal parameter and the adjustment value. In some embodiments, the adjusted CQI value can be generated by modifying the signal parameter by the adjustment value. In some embodiments, modifying the signal parameter includes adding the adjustment value to the signal parameter. In some embodiments, modifying the signal parameter includes subtracting the adjustment value from the signal parameter. Then, in some embodiments, the UE can estimate achievable data rates for different MCS based at least in part on the modified signal parameter. In some embodiments, the UE can select the highest MCS level that can be supported with an acceptable Block Error Rate (BLER) maps this selected MCS level to a corresponding CQI value (e.g., from 0 or 1 (worst channel quality) to 15 (best channel quality)). In some embodiments, the result of Step 208 is an adjusted CQI value.

In Step 210, method 200 can include transmitting from the UE to the base station the adjusted CQI value. In some embodiments, once the adjusted CQI value is received at the base station, the base station can reconfigure the connection between the base station and the UE to optimize the connection performance and reliability.

In some embodiments, Steps 204-210 can be repeated periodically throughout the permanence of the communications session between the base station and the UE.

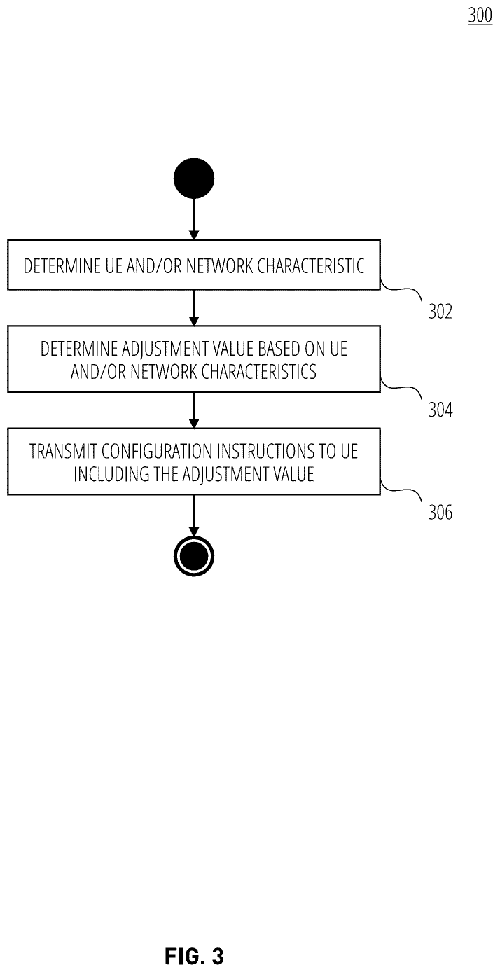

FIG. 3 is a flow diagram illustrating a method for determining an adjustment value according to an embodiment.

In Step 302, method 300 can include determining by a network element of an access network, a core network, a MEC network, or a data network 108 a network characteristic and/or a UE characteristic corresponding to a given UE. In some embodiments, a network characteristic can be subscriber group, QoS flow, or a slicing identifier. In some embodiments, the network characteristic can be a bandwidth allocated to a connection between the UE and a base station of an access network. In some embodiments, a UE characteristic can be a type of UE (e.g., a URLLC device, an eMBB device, a mMTC device, or an IoT device). In some embodiments, the UE characteristic can be a receiver antenna design or arrangement (e.g., single antenna v. multi-antenna). In some embodiments, at least one of the network or UE characteristic can be obtained from a mobility manager (e.g., mobility manager 114) from a subscriber database (e.g., subscriber database 120).

In Step 304, method 300 can include determining an adjustment value for the given UE. For example, in some embodiments, a UE of type mMTC can have an associated adjustment value of 0 dB. In some embodiments, a UE of type eMBB can have different associated adjustment values based on a bandwidth allocation. For example, in some of those embodiments, the UE can have an associated adjustment value of about 2.5 dB when the allocated bandwidth is less than about 5 MHz and an adjustment value of about 3 dB when the allocated bandwidth is greater than about 5 MHZ. In some embodiments, a UE of type URLLC can have an adjustment value of greater than about 3 dB.

In Step 306, method 300 can include transmitting the determined adjustment value to the UE. In some embodiments, the network element can transmit configuration instructions to the UE during a sessions establishment process. In some embodiments, the network element can transmit the configuration instructions periodically as UE and/or network characteristics change. In some embodiments, the network element can transmit the configuration instructions using a DM protocol such as OMA DM or LwM2M.

FIG. 4 is a block diagram of a device according to some embodiments.

As illustrated, the device 400 can include a processor or central processing unit (CPU) such as CPU 402 in communication with a memory 404 via a bus 414. In some embodiments, device 400 can also include one or more input/output (I/O) or peripheral devices 412. Examples of peripheral devices include, but are not limited to, network interfaces, audio interfaces, display devices, keypads, mice, keyboard, touch screens, illuminators, haptic interfaces, global positioning system (GPS) receivers, cameras, or other optical, thermal, or electromagnetic sensors.

In some embodiments, the CPU 402 can comprise a general-purpose CPU. The CPU 402 can comprise a single-core or multiple-core CPU. The CPU 402 can comprise a system-on-a-chip (SoC) or a similar embedded system. In some embodiments, a graphics processing unit (GPU) can be used in place of, or in combination with, a CPU 402. Memory 404 can comprise a non-transitory memory system including a dynamic random-access memory (DRAM), static random-access memory (SRAM), Flash (e.g., NAND Flash), or combinations thereof. In one embodiment, the bus 414 can comprise a Peripheral Component Interconnect Express (PCIe) bus. In some embodiments, bus 414 can comprise multiple busses instead of a single bus.

Memory 404 illustrates an example of non-transitory computer storage media for the storage of information such as computer-readable instructions, data structures, program modules, or other data. Memory 404 can store a basic input/output system (BIOS) in read-only memory (ROM), such as ROM 408, for controlling the low-level operation of the device. The memory can also store an operating system in random-access memory (RAM) for controlling the operation of the device

Applications 410 can include computer-executable instructions which, when executed by the device, perform any of the methods (or portions of the methods) described previously in the description of the preceding Figures. In some embodiments, the software or programs implementing the method embodiments can be read from a hard disk drive (not illustrated) and temporarily stored in RAM 406 by CPU 402. CPU 402 may then read the software or data from RAM 406, process them, and store them in RAM 406 again.

The device 400 can optionally communicate with a base station (not shown) or directly with another computing device. One or more network interfaces in peripheral devices 412 are sometimes referred to as a transceiver, transceiving device, or network interface card (NIC).

An audio interface in Peripheral devices 412 produces and receives audio signals such as the sound of a human voice. For example, an audio interface may be coupled to a speaker and microphone (not shown) to enable telecommunication with others or generate an audio acknowledgment for some action. Displays in Peripheral devices 412 may comprise liquid crystal display (LCD), gas plasma, light-emitting diode (LED), or any other type of display device used with a computing device. A display may also include a touch-sensitive screen arranged to receive input from an object such as a stylus or a digit from a human hand.

A keypad in peripheral devices 412 can comprise any input device arranged to receive input from a user. An illuminator in peripheral devices 412 can provide a status indication or provide light. The device can also comprise an input/output interface in peripheral devices 412 for communication with external devices, using communication technologies, such as USB, infrared, Bluetooth™, or the like. A haptic interface in peripheral devices 412 can provide a tactile feedback to a user of the client device.

A GPS receiver in peripheral devices 412 can determine the physical coordinates of the device on the surface of the Earth, which typically outputs a location as latitude and longitude values. A GPS receiver can also employ other geo-positioning mechanisms, including, but not limited to, triangulation, assisted GPS (AGPS), E-OTD, CI, SAI, ETA, BSS, or the like, to further determine the physical location of the device on the surface of the Earth. In one embodiment, however, the device may communicate through other components, providing other information that may be employed to determine the physical location of the device, including, for example, a media access control (MAC) address, Internet Protocol (IP) address, or the like.

The device can include more or fewer components than those shown in FIG. 4, depending on the deployment or usage of the device. For example, a server computing device, such as a rack-mounted server, may not include audio interfaces, displays, keypads, illuminators, haptic interfaces, Global Positioning System (GPS) receivers, or cameras/sensors. Some devices may include additional components not shown, such as graphics processing unit (GPU) devices, cryptographic co-processors, artificial intelligence (AI) accelerators, or other peripheral devices.

The subject matter disclosed above may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, the subject matter may be embodied as methods, devices, components, or systems. Accordingly, embodiments may, for example, take the form of hardware, software, firmware, or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in an embodiment” as used herein does not necessarily refer to the same embodiment, and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms such as “and,” “or,” or “and/or,” as used herein may include a variety of meanings that may depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, can be understood to convey a singular usage or to convey a plural usage, depending at least in part upon context. In addition, the term “based on” may be understood as not necessarily intended to convey an exclusive set of factors and may, instead, allow for the existence of additional factors not necessarily expressly described, again, depending at least in part on context.

The present disclosure is described with reference to block diagrams and operational illustrations of methods and devices. It is understood that cach block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, application-specific integrated circuit (ASIC), or other programmable data processing apparatus, such that the instructions, which execute via the processor of the computer or other programmable data processing apparatus, implement the functions/acts specified in the block diagrams or operational block or blocks. In some alternate implementations, the functions or acts noted in the blocks can occur out of the order noted in the operational illustrations. For example, two blocks shown in succession can, in fact, be executed substantially concurrently, or the blocks can sometimes be executed in the reverse order, depending upon the functionality or acts involved.

These computer program instructions can be provided to a processor of a general-purpose computer to alter its function to a special purpose; a special purpose computer; ASIC; or other programmable digital data processing apparatus, such that the instructions, which execute via the processor of the computer or other programmable data processing apparatus, implement the functions or acts specified in the block diagrams or operational block or blocks, thereby transforming their functionality in accordance with embodiments herein.

For the purposes of this disclosure, a computer-readable medium (or computer-readable storage medium) stores computer data, which data can include computer program code or instructions that are executable by a computer, in machine-readable form. By way of example, and not limitation, a computer-readable medium may comprise computer-readable storage media for tangible or fixed storage of data or communication media for transient interpretation of code-containing signals. Computer-readable storage media, as used herein, refers to physical or tangible storage (as opposed to signals) and includes without limitation volatile and non-volatile, removable, and non-removable media implemented in any method or technology for the tangible storage of information such as computer-readable instructions, data structures, program modules or other data. Computer-readable storage media includes, but is not limited to, RAM, ROM, EPROM, EEPROM, flash memory or other solid-state memory technology, CD-ROM, DVD, or other optical storage, magnetic cassettes, magnetic tape, magnetic disk storage, or other magnetic storage devices, or any other physical or material medium which can be used to tangibly store the desired information or data or instructions and which can be accessed by a computer or processor.

For the purposes of this disclosure, a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer-readable medium for execution by a processor. Modules may be integral to one or more servers or be loaded and executed by one or more servers. One or more modules may be grouped into an engine or an application.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than or more than all the features described herein are possible.

Functionality may also be, in whole or in part, distributed among multiple components, in manners now known or to become known. Thus, a myriad of software, hardware, and firmware combinations are possible in achieving the functions, features, interfaces, and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example to provide a complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
establishing, by a User Equipment (UE), a communications session with a base station of an access network;
receiving, at the (UE) from a network element communicatively coupled to the access network, an adjustment value corresponding to the UE;
determining, by the UE, a signal parameter corresponding to a signal between the UE and the base station;
modifying, by the UE, the signal parameter based on the adjustment value;
generating, by the UE, an adjusted Channel Quality Indicator (CQI) value based on the modified signal parameter; and
reporting, from the UE to the base station, the adjusted CQI value.

2. The method of claim 1, wherein the signal parameter is selected from the group comprising: a signal strength, a signal-to-noise ratio (SNR), a signal-to-interference-plus-noise ratio (SINR), and a signal-to-interference-plus-distortion ratio (SNDR).

3. The method of claim 1, wherein the UE is a single-antenna receiver UE.

4. The method of claim 1, wherein the adjustment value is based on at least one of a UE characteristic and a network characteristic.

5. The method of claim 4, wherein the at least one of the UE characteristic and the network characteristic is obtained from a subscriber database.

6. The method of claim 1, wherein the UE comprises a device management (DM) node, and wherein the UE receives configuration instructions including the adjustment value from the network element at the DM node using a DM protocol.

7. The method of claim 6, wherein the DM protocol is selected from the group comprising: an Open Mobile Alliance (OMA) Device Management (OMA DM) protocol and an OMA Lightweight Machine to Machine (LwM2M) protocol.

8. A non-transitory computer-readable storage medium for storing instructions executable by a processor, the instructions comprising:
establishing a communications session between a User Equipment (UE) and a base station of an access network;
receiving, from a network element communicatively coupled to the access network, an adjustment value corresponding to the UE;
determining a signal parameter corresponding to a signal between the UE and the base station;
modifying the signal parameter based on the adjustment value;
generating an adjusted Channel Quality Indicator (CQI) value based on the modified signal parameter; and
reporting, to the base station, the adjusted CQI value.

9. The non-transitory computer-readable storage medium of claim 8, wherein the signal parameter is selected from the group comprising: a signal strength, a signal-to-noise ratio (SNR), a signal-to-interference-plus-noise ratio (SINR), and a signal-to-interference-plus-distortion ratio (SNDR).

10. The non-transitory computer-readable storage medium of claim 8, wherein the UE is a single-antenna receiver UE.

11. The non-transitory computer-readable storage medium of claim 8, wherein the adjustment value is determined by the network element based on at least one of a UE characteristic and a network characteristic.

12. The non-transitory computer-readable storage medium of claim 11, wherein the at least one of the UE characteristic and the network characteristic is obtained from a subscriber database of a core network communicatively coupled to the access network.

13. The non-transitory computer-readable storage medium of claim 8, wherein the UE comprises a device management (DM) node, and wherein the UE receives configuration instructions including the adjustment value from the network element at the DM node using a DM protocol.

14. The non-transitory computer-readable storage medium of claim 13, wherein the DM protocol is selected from the group comprising: an Open Mobile Alliance (OMA) Device Management (OMA DM) protocol and an OMA Lightweight Machine to Machine (LwM2M) protocol.

15. A device comprising a processor configured to:
establish a communications session with a base station of an access network;
receive, from a network element communicatively coupled to the access network, an adjustment value corresponding to the device;
determine, a signal parameter corresponding to a signal between the device and the base station;
modify the signal parameter based on the adjustment value;
generate an adjusted Channel Quality Indicator (CQI) value based on the modified signal parameter; and
report, to the base station, the adjusted CQI value.

16. The device of claim 15, wherein the signal parameter is selected from the group comprising: a signal strength, a signal-to-noise ratio (SNR), a signal-to-interference-plus-noise ratio (SINR), and a signal-to-interference-plus-distortion ratio (SNDR).

17. The device of claim 15, wherein the device is a single-antenna receiver User Equipment (UE).

18. The device of claim 15, wherein the adjustment value is determined by the network element based on at least one of a UE characteristic corresponding to the device and a network characteristic, wherein the network element obtains the at least one of the UE characteristic and the network characteristic from a subscriber database of a core network communicatively coupled to the access network.

19. The device of claim 15, further comprising a device management (DM) node, and wherein the processor is further configured to receive configuration instructions from the network element at the DM node using a DM protocol.

20. The device of claim 19, wherein the DM protocol is selected from the group comprising: an Open Mobile Alliance (OMA) Device Management (OMA DM) protocol and an OMA Lightweight Machine to Machine (LwM2M) protocol.
